(19) United States
(12) Patent Application Publication
(10) Pub. No.: US 2010/0086318 A1
(43) Pub. Date: Apr. 8, 2010

(54) FIXING JAM DETECTING IMAGE FORMING APPARATUS

(76) Inventor: Yasuhiko NISHINO, Hitachinaka-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/572,684

(22) Filed: Oct. 2, 2009

(30) Foreign Application Priority Data
Oct. 3, 2008 (JP) 2008-258470
Jun. 2, 2009 (JP) 2009-133359

(51) Int. Cl. G03G 15/00

(52) U.S. Cl. 399/21

(57) ABSTRACT

An image forming apparatus includes a fixing device that fixes a toner image onto a printing medium. The fixing device includes a fixing member heated by a heating device, a pressurizing member that freely rotatably pressure contacts the fixing member and creates a fixing nip that allows a printing medium to pass and melts the toner image thereon. A separation pick is arranged on a printing medium ejection side of the fixing nip and prevents the printing medium from winding up the fixing member. Three sensors are arranged downstream of the separation pick at a center and both side ends in the widthwise direction of the fixing nip to detect passage of the printing medium. A fixing jam detection device is provided to detection occurrence of jam based on the detection of the three sensors.

### CROSS REFERENCE TO RELATED APPLICATIONS

This application claims priority under 35 USC §119 to Japanese Patent Application Nos. 2008-258470 and 2009-133359, filed on Oct. 3, 2008, and Jun. 2, 2009, respectively, the entire contents of which are herein incorporated by reference.

### BACKGROUND OF THE INVENTION

1. Field of the Invention

The present invention relates to a fixing device and an image forming apparatus including the fixing device. More particularly, the present invention relates to a fixing device for fixing toner onto a sheet as a printing medium conveyed by a conveyance device by applying heat, and an image forming apparatus, such as a copier, a printer, a facsimile, a multifunctional machine combining these functions, etc., including the fixing device, which is capable of forming and transferring a toner image onto the sheet using an electro-photographic system and fixing the toner image after the transfer process.

2. Discussion of the Background Art

Conventionally, an image forming apparatus using an electro-photographic system is well known. For example, a latent image is formed on a surface of a photoconductive drum as an image bearer, and is visualized by toner as developer. The developed image is then transferred onto a printing medium (or a sheet) by a transfer device. Then, the toner image is fixed by a fixing device using pressure and heat or the like. The printing medium subjected to the fixing is conveyed through a sheet ejection path and is ejected to an outside of the apparatus.

The fixing device includes arrangement of a fixing rotation member constituted by either opposing rollers, belts, or a combination of those, and fixes the toner image on the printing medium using the heat and pressure while sandwiching the same.

The fixing rotation member may include a fixing belt wound around two rollers, the surface of which is heated, and a pressuring roller contacting the fixing belt as discussed in the Japanese Patent Application Laid Open No. 2008-58757. Otherwise, a fixing roller, the surface of which is heated, and a pressuring belt contacting the fixing roller are arranged. In either configuration, the fixing member and the pressuring member contact each other and create a fixing nip at the contact section.

The printing medium having been subjected to the toner transfer and arriving at the fixing device enters the fixing nip as the contact between the fixing member and the pressuring member. The toner image is heated and pressurized when passing the fixing nip.

A separation pick or a separation plate is arranged downstream of the fixing nip in the conveyance direction on the side of a fixing member while either contacting or separating from the fixing member. Thus, the printing medium launched from the fixing nip winding up the surface of the fixing member is separated and conveyed to the outside of the fixing device.

At this moment, jamming of the printing medium sometimes occurs at the fixing nip.

Some of the conventional image forming apparatuses is enabled to detect a jam sheet in the fixing device. For example, a detection device for detecting a printing medium is arranged downstream of the fixing roller in the vicinity of the center of the fixing nip. Then, the detection device recognizes that no jam occurs when detecting the leading end of the printing medium. Whereas when not detecting the printing medium within a prescribed time period during a printing operation, the detection device stops conveyance thereof regarding that printing medium jam occurs upstream as discussed in the Japanese Patent Application Laid Open No. 2005-181689. Further, an image formation process is interrupted when the detection device continuously detects the printing medium for a prescribed time period during the printing operation,

However, still jam occurs in such a conventional image forming apparatus. For example, as illustrated in FIG. 1, one widthwise end of the printing medium P sometimes cannot be peeled off and hooks into the separation pick and is divided into two, thereby advancing like a snake. However, the detection device S3 arranged at the center (i.e. a central sensor) detects the passage of the printing medium P even such a situation regarding that the jam does not occur and the printing medium is continuously conveyed. Thus, since the leading end is not normally conveyed along the conveyance path due to snaky behavior, a detection device arranged downstream, not shown, detects occurrence of the jam and stops conveyance thereof. At this moment, the printing medium P gets into under the separation pick, and pressure contacts both of the fixing member and the pressuring member, thereby becoming an accordion like state. Otherwise, removal of the printing medium P becomes difficult due to entering of the trailing end thereof into the fixing device. Otherwise, the separation pick pressure contacts and damages the surface of the fixing member.

### SUMMARY OF THE INVENTION

Accordingly, an object of the present invention is to improve such background arts technologies and provides a new and novel image forming apparatus comprises a fixing device configure to fix a toner image. An image forming apparatus includes a fixing device that fixes a toner image onto a printing medium. The fixing device includes a fixing member heated by a heating device, a pressurizing member that freely rotatably pressure contacts the fixing member and creates a fixing nip on the fixing member. A separation member is arranged downstream of the fixing nip and prevents the printing medium from winding up the fixing member. Three sensors are aligned downstream of the separation member at widthwise center and both side ends of a conveyance path that conveys the printing medium. A fixing jam detection device is provided to detect jamming based on outputs of the three sensors.

In another aspect, the fixing jam detection device detects the jamming when none of the three sensors detect the passage of the printing medium when a prescribed time period T has elapsed after the printing medium passes through a prescribed position upstream of the fixing device.

In yet another aspect, the prescribed time period T is changed in accordance with one of a type of the printing medium and a number of consecutively fed printing mediums.

In yet another aspect, the fixing jam detection device detects jamming only with the central sensor when a distance between the two end sensors and is larger than the width of the printing medium, and detects the jamming with three sensors when the distance between the two end sensors is less than the width of the printing medium.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a plan view illustrating a typical condition of a sheet snaking on a path downstream of a fixing device;

FIG. 2 is a cross sectional view illustrating a fixing device used in an image forming apparatus according to one embodiment of the present invention;

FIG. 3 is a cross sectional view illustrating an image forming apparatus according to one embodiment of the present invention;

FIG. 4 is a perspective view illustrating a principal part of a sheet ejection side of a fixing nip created on the fixing device of FIG. 2;

FIG. 5 is a cross sectional view illustrating the principal part of the sheet ejection side of the fixing nip of FIG. 4;

FIG. 6 is a chart illustrating a first sensor detection circuit constituting a fixing jam detection device;

FIG. 7 is a time chart illustrating a sequence of sheet detection by sensors included in the detection circuit of FIG. 6;

FIG. 8 is a plan view illustrating the typical condition of the sheet of FIG. 2;

FIG. 9 is a chart illustrating a second sensor detection circuit constituting another fixing jam detection device;

FIG. 10 is a time chart illustrating a sequence of sheet detection by sensors included in the other detection circuit of FIG. 9;

FIG. 11 is a cross sectional view illustrating the fixing device including another types of pressuring member and fixing member according to another embodiment of the present invention;

FIG. 12 is a cross sectional view illustrating the fixing device including still another types of pressuring member and fixing member according to yet another embodiment of the present invention; and

FIG. 13 is a plan view illustrating a fixing device including another separation pick according to the present invention.

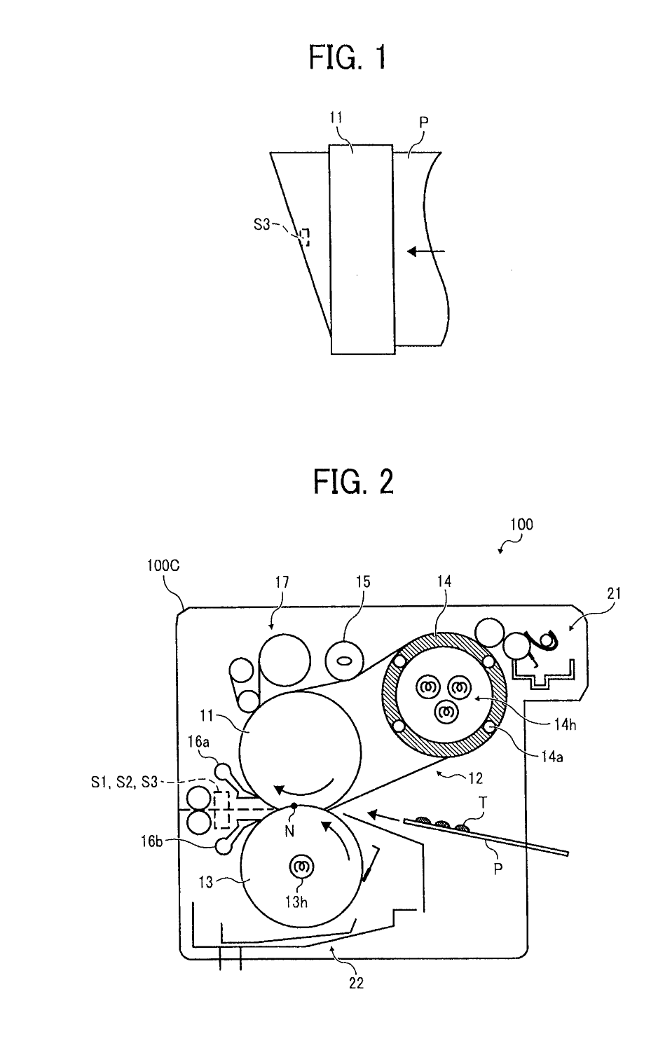

### DESCRIPTION OF THE PREFERRED EMBODIMENTS

Referring now to the drawing, wherein like reference numerals designate identical or corresponding parts throughout several views in particular in FIG. 2, an exemplary fixing device included in an image forming apparatus according to one embodiment of the present invention is described. As shown, the fixing device 100 includes a fixing member (e.g. a fixing belt 12) arranged within a fixing cover 100c being suspended by a fixing roller 11 and a heat applying roller 14 under a prescribed amount of tension, a pressurizing member (e.g. a pressurizing roller 13) freely rotatably pressure contacting the fixing member at the lower side for creating a fixing nip N, and plural separation picks 16a arranged in a widthwise (i.e. main scanning) direction of the fixing member in the vicinity thereof for preventing a sheet P as a printing medium from winding around the fixing member. Also included are plural separation picks 16b arranged in a widthwise (i.e. main scanning) direction of the pressurizing member in the vicinity thereof for preventing the sheet P from winding around the pressurizing member, and a cleaning mechanism 17 pressurizing a cleaning web and cleaning the fixing belt 12. Further, separate from the fixing device 100, three sensors S1 to S3 collectively constituting a fixing jam detection device 18 mentioned later in detail are arranged in the vicinity of a sheet ejection path downstream of the separation picks 16a and 16b to detect passage of the sheet P.

The fixing belt 12 is endless and has a two-layer construction in a cross section including a substrate made of nickel, stainless or polyimide or the like, and an elastic layer, such as silicone layer, etc. The fixing roller 11 includes a metal core and silicone rubber overlying the metal core. To cause the fixing belt 12 to absorb heat and thereby decreasing a warm up time period, foam silicone rubber may be used. The heating roller 14 includes a hollow member made of aluminum or iron, and a heat source having a heater 14h, such as a halogen heater, etc. The heat source can include an induction heating mechanism (IH). In the cross section of the hollow roller of the heat applying roller 14, a heat pipe system 14a having plural hollow pipes extending in the widthwise direction being embedded at the same interval in the circumferential direction of the heat applying roller 14 is provided. Due to the pipe system 14a, heat transmission from the heater 14h to the surface of the roller is improved, so that the fixing belt can be quickly heated uniformly.

When the fixing device 100 is to be driven, the fixing belt 12 is rotated by the fixing roller 11 rotating clockwise in the drawing being biased by the tension roller 15 under appropriate tension in a direction of ejecting the sheet P (i.e. clockwise in FIG. 2), while the pressurizing roller 13 is driven. The driven roller is not limited to the fixing roller 11 and can be either the pressurizing roller 13 or the heat applying roller 14. When executing a fixing operation, the fixing belt 12 is heated by the heater 14h arranged in the heat applying roller 14 until temperature detected by a thermistor, not shown, arrives at a prescribed level suitable for toner fixing. The fixing member is not limited to the above-mentioned fixing belt 12, and can include a hollow cylindrical roller.

The pressurizing roller 13 is generally cylindrical including a metal core made of aluminum or iron or the like and an elastic layer, such as silicone rubber, etc. The pressurizing roller 13 may be biased by a pressure applying/removing device to move and pressure contact the fixing belt 12 or is separated therefrom so that the contact pressure is removed. When the fixing device 100 is to be driven, the pressure applying/removing device biases the pressurizing roller 13 toward the fixing belt 12 to pressure contact the fixing belt 12 under a prescribed pressure. When necessary, the pressurizing roller 13 is heated to a prescribed level by the heater 13h installed therein. The pressurizing member is not limited to a roller type as shown in FIG. 2, and can include an endless belt type suspended by a pair of rollers.

The surface of the fixing belt 12 is heated to a prescribed level when rotating with the pressurizing roller 13. Thus, when a sheet P having a not fixed toner image is fed to the fixing nip N, the toner image is heated and melted thereby fixed on the sheet P by the heat and pressure at the fixing nip N.

When ejected from the fixing nip N, the sheet P having the fixed toner image sometimes is launched winding around either the fixing belt 12 or the pressurizing roller 13. To resolve such a problem, a pair of oil coating devices 21 and 22 is provided to respectively coat oil onto the fixing belt 12 and the pressurizing roller 13 so as to improve the releasing performance. The oil is preferably heat resistant and non-volatile such as silicone oil, etc. Further, the tips of the separation picks 16a and 16b engage with the leading end of the sheet P to separate the sheet P from the fixing belt 12 and the pressurizing roller 13. The sheet P ejected from the fixing nip N is launched from the fixing device 100 onto a prescribed sheet ejection path. Further, the three sensors S1 to S3 monitor passage of the sheet P, so that jamming can be detected based on detection of the sensors S1 to S3 as mentioned later in detail.

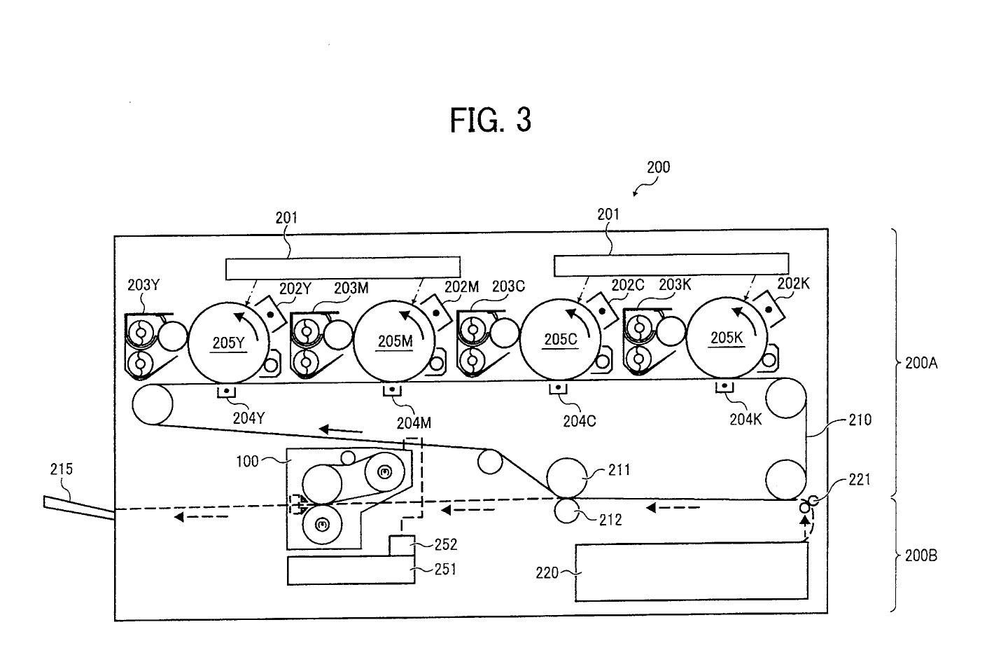

Now, an exemplary entire configuration of the image forming apparatus according to one embodiment of the present invention is described with reference to FIG. 3. As shown, a tandem type color copier is illustrated as an image forming apparatus of one embodiment of the present invention. The color copier 200 includes a fixing device 100, three sensors S1 to S3, and a fixing jam detection device 18 for detecting sheet jam based on detection of the three sensors S1 to S3. The color copier 200 operates at high speed and includes an image formation section 200A at a hart of the apparatus body, a sheet feeding section 200b located below the image formation section 200A, and an image reading section, not shown, located above the image formation section 200A. The image formation section 200A includes the above-mentioned fixing device 100.

In the image formation section 200A, there is arranged a transfer belt 210 having a transfer plane extending in a horizontal direction. On the upper surface of the transfer belt 210, there are provided mechanisms for forming images of complementary resolution colors (Yellow, Magenta, Cyan, and Black). Specifically, photoconductive members 205Y to 205K serving as image bearers capable of carrying toner images of the complementary colors are arranged side by side along the transfer plane of the transfer belt 210.

The respective photoconductive members 205Y to 205K are a drum type rotatable counterclockwise. Around the respective photoconductive members 205Y to 205K, optical writing devices 201, charge devices 202Y to 202K, developing devices 203Y to 203K, primary transfer devices 204Y to 204K, and a cleaning device are almost arranged. Different mono color toner is stored in each of the developing devices 203 to 203K.

The transfer belt 210 is wound around driving and driven rollers and travels in the same direction at respective positions opposing the photoconductive members 205Y to 205K. Further, a transfer roller 212 is arranged opposing a roller 211 as one of the driven roller. A conveyance path extends laterally for conveying a sheet P from the transfer roller 212 to the fixing device 100.

The sheet feeding section 200B includes a sheet feeding tray 220 for accommodating the sheets P, and a conveyance mechanism for separating and conveying the upper most sheet P one by one in the sheet feeding tray 220 toward the transfer roller 212. The sheet P conveyed from the sheet feeding tray 220 then collides and temporarily stops at a registration roller 221. In synchronism with an image output, the registration roller 221 restarts rotating and conveys the sheet P to bring the same into transfer and fixing processes.

When image formation is executed in the image forming apparatus 200, the surface of the photoconductive member 205Y is uniformly charged by the charge device 202Y, and forms a latent image based on image information transmitted from the image reading section. The latent image is developed to be a toner image by the developing device 203Y accommodating the yellow toner, and is transferred by the primary transfer device 204Y under a prescribed bias onto a transfer belt 210 as primary transfer. In the rest of the photoconductive members 205M to 205K, the similar image formation operations are executed using different color toners and toner images of respective colors are transferred and superimposed one after another onto the transfer belt 210 receiving an electrostatic force.

Then, the toner image as a result of the primary transfer onto the transfer belt 210 from the photoconductive members 205Y to 205K is transferred onto the sheet P conveyed by the rollers 211 and 212. The sheet P with the transferred toner image is further conveyed to the fixing device 100, so that the toner image is fixed at a fixing nip N between the fixing belt 12 and the pressurizing roller 13. Plural oil coating devices coat the fixing belt 12 and the pressurizing roller 13 with an appropriate amount of oil. Plural separation picks 16a and 16b arranged at the exit side of the fixing nip N function to eject the sheet P to the outside of the nip N while preventing the sheet P from winding up around the fixing belt 12 and the pressurizing roller 13. Then, the sheet P is launched onto a stacker along the ejection path.

According to one embodiment of the present invention, the image forming apparatus including the fixing device 100 can obtain a sophisticated fixing separation function capable of accommodating various types of sheets, such as thin and thick papers, a leading end marginal sheet, etc.

As an accessory of the fixing device 100, an oil tank 251 for collecting the oil used in the fixing device 100 can be provided for improving releasing performance of the sheet P. An oil circulation mechanism such as an oil pump can also provided for supplying the fixing device again with the oil stored in the oil tank 251.

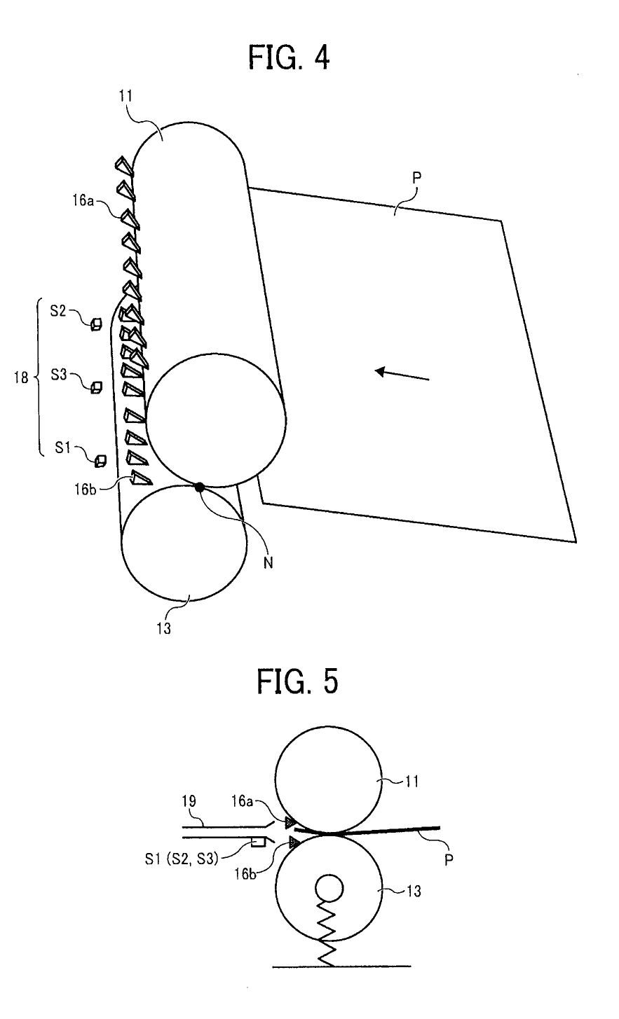

Now, a principal configuration of one of embodiments of the present invention is described with reference to FIGS. 4 and 5. As shown, not important devices are omitted from the fixing device of FIG. 2.

Specifically, plural separation picks 16a are arranged on the ejection side of the fixing nip N in a widthwise direction of the fixing belt 12, not shown, with their tips being arranged in the vicinity thereof for preventing the sheet P from winding up the fixing belt 12. Further included are plural separation picks 16b arranged on the ejection side of the fixing nip N in a widthwise direction of the pressurizing roller 13 with their tips contacting thereof for preventing the sheet P from winding up the pressurizing roller 13. Further, three sensors S1 to S3 are arranged as a fixing jam detection devices 18 downstream of the separation picks 16a and 16b.

The sensors S1 to S3 detect passage of the sheet P by sensing presence thereof. The sensor S1 (i.e., an end sensor) is arranged at one end in the widthwise direction of the fixing nip N corresponding to the operator side (i.e., apparatus front side) of the image forming apparatus 200. The sensor S2 (i.e., an end sensor) is arranged at the other end in the widthwise direction of the fixing nip N opposite to the operator side (i.e., apparatus rear side) of the image forming apparatus 200. The sensor S3 (i.e., a central sensor) is arranged at a center in the widthwise direction of the fixing nip N. These sensors S1 to S3 are aligned at the same interval from the fixing nip N.

A photo interrupter using a filler or a reflection type photo sensor or the like is used as the sensors S1 to S3. However, a non-contact type photo sensor not affecting both of the conveyance of the sheet P and image formation is preferably employed. When the photo sensors S1 to S3 are employed, the sensors S1 to S3 are arranged below in the vicinity of the sheet ejection path 19 as shown in FIG. 5. Thus, when the sheet P is absent, a signal level of each of the sensors S1 to S3 is in a turnoff condition. However, when the sheet P comes above the sensors S1 to S3, the rear side of the sheet P (an opposite side of the image formation side) reflects lights from the sensors S1 to S3. Then, the sensors S1 to S3 receive the reflected lights and the signal levels change to be in a turn on condition, thereby the presence of the sheet P can be recognized by a light receiving signal. At this moment, since the sensors S1 to S3 are arranged in the vicinity of the separation picks 16a and 16b, a leading edge of the sheet P launched from the fixing nip N and its passage condition can be immediately detected in the widthwise direction.

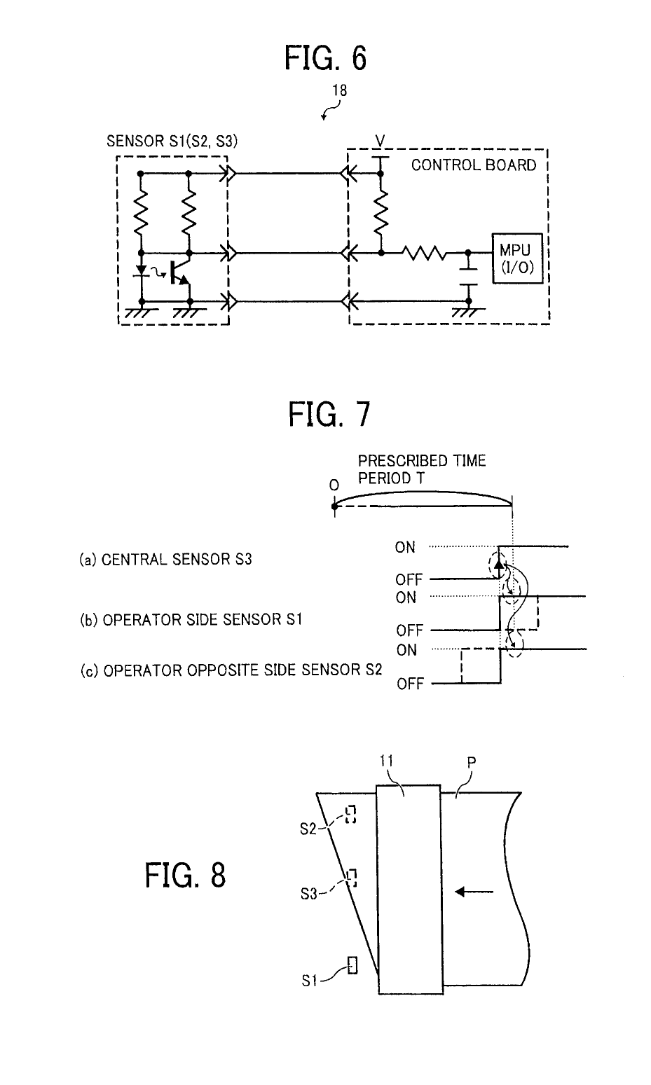

Further, as shown in an equivalent circuit of FIG. 6, the sensors S1 to S3 are connected to a control section (e.g. a control base plate) provided in the image forming apparatus 200. Thus, the sensors S1 to S3 are supplied with power by a power source mounted on the control base plate, and transmit signals to a micro processor (MPU). The MPU executes various controls for the image forming apparatus 200 and determines if jam occurred based on detection signals from the sensors S1 to S3. Specifically, the fixing jam detection device 18 is formed from the sensors S1 to S3 and a region included in the MPU for determining occurrence of the sheet jam.

In one embodiment of the present invention, when none of the sensors S1 to S3 detect the passage of the sheet P when a prescribed time period has elapsed after the sheet P passes through a prescribed position (e.g. a registration roller 221) on the conveyance path upstream of the fixing device 100, the fixing jam detection device recognizes occurrence of the sheet jam as described below more in detail.

Initially, a situation when the sheet P is normally ejected from the fixing nip N is described with reference to FIG. 7, in which a sequence of detecting the sheet P by the sensors S1 to S3 is illustrated. Specifically, the fixing jam detection device detects occurrence of jam in a sequence as described below. In step S11, an elapsing time starts being counted from a time point “O” when the sheet P is conveyed from the registration roller 221. In step S12, when the elapsing time reaches a prescribed time period T, detection conditions of the sensors S1 to S3 are checked. At this moment, since the sheet P is normally ejected from the fixing nip N, the leading end thereof simultaneously passes through the sensors S1 to S3 before the prescribed time period T has elapsed. Thus, as shown by a solid line in FIG. 7, all of the sensors S1 to S3 change from turn off conditions (i.e., sheet P no detection) to turn on conditions (i.e., sheet P detection). In step S13, the fixing jam detection device 18 checks signal levels of the sensors S1 and S2 (i.e., level detection) when the prescribed time period T has elapsed. Specifically, when the signal levels are in the turn on conditions, it is regarded that the sheet P has passed. Whereas it is detected that the sheet P has not yet passed when they are in the turn off conditions. Further, the fixing jam detection device 18 a checks signal condition of the sensor S3 (i.e., edge check) if the turn off condition is changed to the tune on condition before the prescribed time period T has elapsed. Specifically, when the signal condition is changed, it is regarded that the sheet P has passed. If not, it is regarded that the sheet P has not yet passed. As shown by the solid line in FIG. 7, signal conditions of the sensors S1 and S2 represent turn on, while the sensor S3 changes the signal condition before the prescribed time period T has elapsed. In step S14, the fixing jam detection device 18 determines as a detection result that jam does not occur when detecting that all of the sensors S1 to S3 detect passage of the sheet P. Whereas the fixing jam detection device 18 determines as a detection result that jam has occurred when detecting that at least any one of the sensors S1 to S3 does not detect the passage of the sheet P. As shown by the solid line in FIG. 7, since all of the sensors S1 to S3 detect passage of the sheet P, it is determined that the jam has not occurred. Thus, in step S15, since the fixing jam detection device 18 determined that jam has not occurred, an image formation job in process is continued.

Now, a situation where the sheet P is abnormally separated at the fixing nip N is described with reference to FIG. 8, wherein the fixing roller 11, the plural sensors S1 to S3, and the sheet P are typically illustrated. As shown, when a prescribed time period T has elapsed after the sheet p passes through a prescribed position (e.g. the registration roller 221) upstream of the fixing device 100 on the conveyance path for the sheet P, the end of the sheet P on the operator side is not successfully separated by the separation pick 16a and slightly hooks into it. Thus, the sheet P is ejected while snaking through the path.

Then, jam detection by the fixing jam detection device 18 is executed as follows:

In step S21, an elapsing time starts being counted from a time “O” when the sheet P is conveyed from the registration roller 221. In step S22, when the elapsing time reaches the prescribed time period T, detection conditions of the sensors S1 to S3 are checked. At this moment, since the leading end of the sheet P obliquely passes through the sensors S1 to S3 in relation to its alignment direction, and the sensors S2 and S3 are intercepted while the sensor S1 is not as shown, a detection performance of the sensors S1 to S3 is obtained as shown by a dotted line back in FIG. 7. Specifically, in step S23, the fixing jam detection device 18 checks signal levels of the sensors S1 and S2 and a presence of signal change from turn off to turn on conditions of the sensor S1 when the prescribed time period T has elapsed. As shown by the dotted line, since the sensor S2 is in the turn on condition when the prescribed time period T has elapsed, while the sensor S3 has changed its signal, but the sensor S1 is still in the turnoff condition when the prescribed time period T has elapsed, the fixing jam detection device 18 determines that jam occurs as a detection result in step S24. Because, the sensors S2 and S3 detect passage of the sheet P, the sensor S1 does not. Then, in step S25, since the fixing jam detection device 18 has determined that the jam occurs, an image formation job in the process and driving of the fixing device 100 are immediately stopped. After that, a prescribed alarm is displayed on an operation panel of the image forming apparatus. The display can include indication of occurrence of jam at the fixing device and/or removal of a jam sheet P, for example.

Hence, the jam caused by slight snake of the sheet P, conventionally impossible to detect, can be detected even before the sheet P is largely enters the fixing device 100. Thus, a serious jam problem such that the sheet P deeply entering the fixing device (fixing belt 12) or the like and becomes an accordion state depressing the separation pick 16a or that the trailing end of the sheet P enters the fixing device is avoided. As a result, the jam sheet P can be readily removed. The above-mentioned system is especially effective when the separation pick 16a is separately arranged in the vicinity of the fixing member (the fixing belt 12). Further avoided is a problem that the separation pick 16a depressed by the accordion state sheet P damages the surface of the fixing member or the like.

Even though a situation where only the sensor S1 does not detect passage of the sheet P is described in this embodiment, detect conditions of the sensors S1 to S3 change in accordance with a sheet ejection condition on the path downstream of the fixing nip N. Thus, when one of the sensors S2 and S3 or any two or all of the sensors S1 to S3 do not detect the passage of the sheet P, the fixing jam detection device 18 determines that the jam occurs on the same manner.

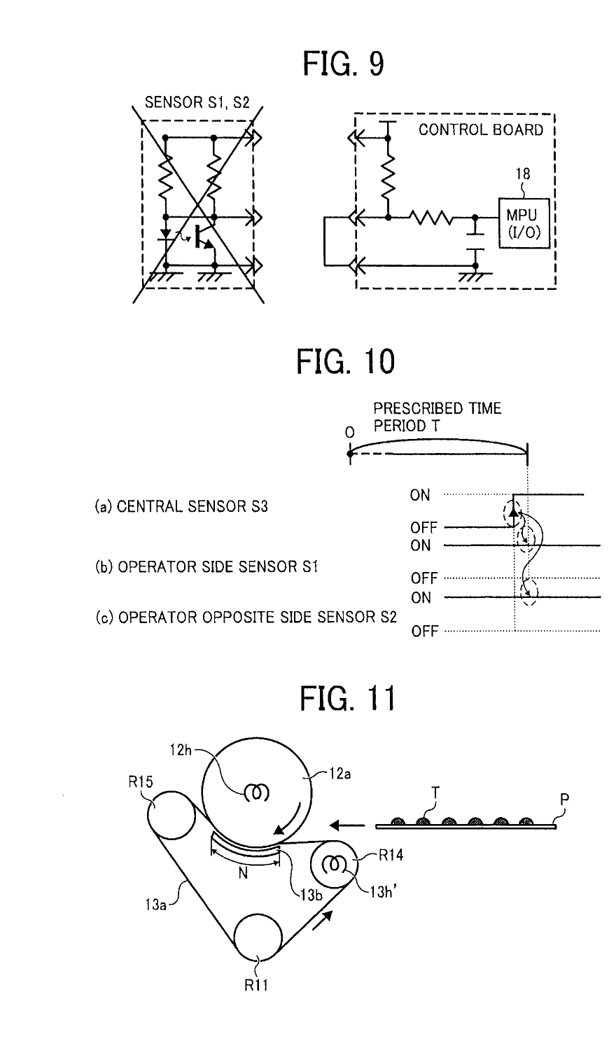

Further, in one embodiment of the present invention, the central sensor S3 detects passage of the leading end of the sheet P by obtaining a detection signal that changes from turn off to turn on conditions (i.e. edge detection), whereas the remaining two side end sensors S1 and S2 detect presence of the sheet P at that time point (i.e. level detection of a turn on condition) (i.e., presence of the sheet). Even incapable of detecting the snake jam, an image forming apparatus that only includes the central sensor S3 excluding the end sensors S1 and S2 can detect jamming based on determination if a sheet passes by employing the fixing jam detection device 18 as shown in FIG. 9.

Specifically, as shown, an exemplary sensor detection circuit constitutes the fixing jam detection device 18 excluding the end sensors S1 and S2. A cross mark in the drawing represents that an image forming apparatus does not include the end sensors S1 and S2. Specifically, as shown, in the detection circuit (e.g. a sensor input/output signal receiving circuit), connection terminals connected to the sensors S1 and S2 use are connected to each other by a jumper connector, and are grounded. Thus, signals are always in a turn on condition representing as if the sensors S1 and S2 detect the sheet P. Then, only the central sensor S3 detects the sheet P (e.g. edge detection). Thus, the fixing jam detection device 18 can detect jam occurrence only based on the signal from the central sensor S3 avoiding interruption of the signals from the side end sensors S1 and S2 as shown in FIG. 10. Thus, according to one embodiment of the present invention, since a control program of the fixing jam detection device 18 does not need to recognize presence of sensors, the fixing jam detection device 18 can detect jamming even in the image forming apparatus of FIG. 9 if unifying micro codes related to electric connection between the sensors and a control base plate and executing common detection control.

Further, the fixing jam detection device 18 can detect the trailing end of the sheet P passing through the fixing nip N with the central sensor S3. By detecting the trailing end, successful passage of the sheet P through the fixing nip N without causing the jam can be checked. Further, since the central sensor S3 detects the trailing end, the fixing jam detection device 18 can control jam related operations using the central sensor S3 even in the conventional image forming apparatus.

Further, the above-mentioned prescribed time period T is preferably adjusted in accordance with a type of sheet P and an amount of consecutively fed sheets, so that appropriate detection can be achieved by properly advancing or delaying detection time of each of the sensors S1 to S3. For example, the prescribed time period T can be calculated as follows, wherein “t” represents a necessary time period when a standard sheet P is used, “a” represents a value determined in accordance with a type of the sheets P, such as a coat sheet, a special sheet, an envelope, etc., or an amount of consecutively fed sheets, such as copies per minute, etc., changed in accordance with a thin or thick paper:

T=t+a.

Further, in accordance with a size and a type of the sheet P used in the image forming apparatus, one or more sensors to obtain detection result are preferably selected by the fixing jam detection device 18 among the sensors S1 to S3.

For example, when a distance between the two end sensors S1 and S2 (i.e., a width in the main scanning direction) is larger than the width of the sheet P (i.e., width of the sheet P<Distance between two end sensors S1 and S2), the fixing jam detection device 18 detects jam occurrence only with the central sensor S3. Thus, a narrow sheet P impossible for the sensors S1 and S2 to detect can be normally detected.

Further, when the distance between the two end sensors S1 and S2 is not larger than the width of the sheet P (i.e., width of the sheet P≧Distance between two end sensors S1 and S2), the fixing jam detection device 18 detects jam occurrence with these three sensors S1 to S3. Thus, the jam caused by slight snake of the sheet P can be detected as mentioned earlier.

Further, when a sheet P, such as a ledger sheet, etc., includes punch holes at its one end, the fixing jam detection device 18 is preferably controlled to detect jam occurrence only with the central sensor S3. Specifically, since the sensors S1 and S2 possibly omit detection of the sheet P at the positions of the punch holes when the punch holes are located at the one end in the width wise direction of the sheet P, only the central sensor S3 detects the sheet P, and jam detection is executed based on the detection result.

Further, the sensors S1 to S3 can preferably be selected based on operator information of the sheet P, such as a size, a type, etc., included in the image forming apparatus.

When the jam occurs and the image forming apparatus stops operation, an operator withdraws the fixing device 100 and removes the jam sheet P from the fixing nip N and attaches the fixing device 100 to the original position, thereby causing the image forming apparatus to be used. Further, it is preferable for the fixing jam detection device 18 to detect remaining of the jam sheet P with the central sensor S3 during a term from when the jam occurs to when the next fixing process starts. As a result, new jamming caused when a previous jam sheet P partially remains (after removal) and the next sheet P is newly fed can be prevented. Beside, by detecting the partial remaining of the jam sheet only with the central sensor S3, the image forming apparatus only including the central sensor S3 can achieve the same function. Specifically, when the fixing jam detection device 18 is adopted to the conventional image forming apparatus including the sensor detection circuit of FIG. 9, the detection circuit connected to the end sensors S1 and S2 always detects that sheet P is present. As a result, detection of partial remaining of the jam sheet P results in error if executed based on such detection result. Then, signals of the detection circuits related to the side end sensors S1 and S2 are neglected as mentioned above, and the partial remaining of the jam sheet P is detected only based on a signal of the central sensor S3. As a result, erroneous detection of the partial remaining of the jam sheet P can be prevented, and accordingly, the detection is accurate.

Further, as shown in FIG. 3, a gate 213 is sometimes arranged downstream of the conveyance path for the sheet P of the fixing device 100 to branch off and switch the sheet conveyance path. Specifically, two sheet conveyance paths are provided for either ejecting the sheet P onto the stacker 215 or reversing and returning the sheet P to a sheet conveyance path for executing image formation on the back side thereof. Then, a time for switching the gate 213 is preferably determined by a (edge) detection time when the central sensor S3 detects the sheet P. Specifically, the gate is switched when a prescribed time has elapsed after the central sensor S3 detects the sheet P, so that the sheet P is appropriately conveyed.

Now, a modified fixing device is described with reference to FIG. 11, in which another types of pressurizing and fixing members are employed. As shown, a fixing roller 12a is freely rotatably arranged in the upper side.

To the lower side? of the fixing roller 12a, a pressurizing belt 13a rotatably suspended around plural rollers R11, R14, and R15 contact, so that a fixing nip N is formed by a backup member 13b serving as a pressurizing pad arranged on the backside of the pressuring belt 13a. Further, the fixing roller 12a is heated by a heater 12h. The pressurizing belt 13a is heated by a heater 13h′.

Specifically, a roller type-fixing member can include a heating source, and the pressurizing member can be a pressurizing belt wound around plural rollers.

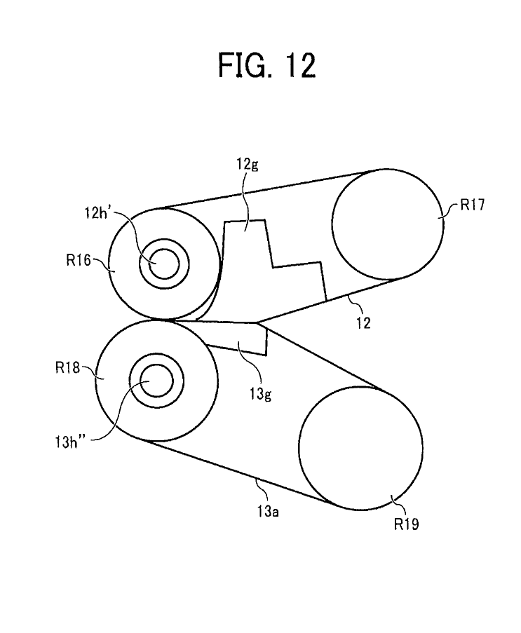

Further, as shown in FIG. 12, both of the fixing member and pressurizing member can be belt types. Specifically, a fixing belt 12 as a fixing member is suspended by rollers R16 and R17 and a guide member 12g, and is driven rotated when the roller R17 is driven by a divining section Not shown. A pressurizing belt 13a as a pressurizing member is wound around rollers R18 and R19 and a guide member 13g. The roller R18 biases the pressurizing belt 13a and the fixing belt 12 against the roller R16. The rollers R18 and R16 are driven rotated at the same speed with each other. The rollers R18 and R16 are heated by heaters 12h′ and 13h′ as heating devices installed in the respective rollers, and heat the fixing belt 12 and the pressurizing belt 13a.

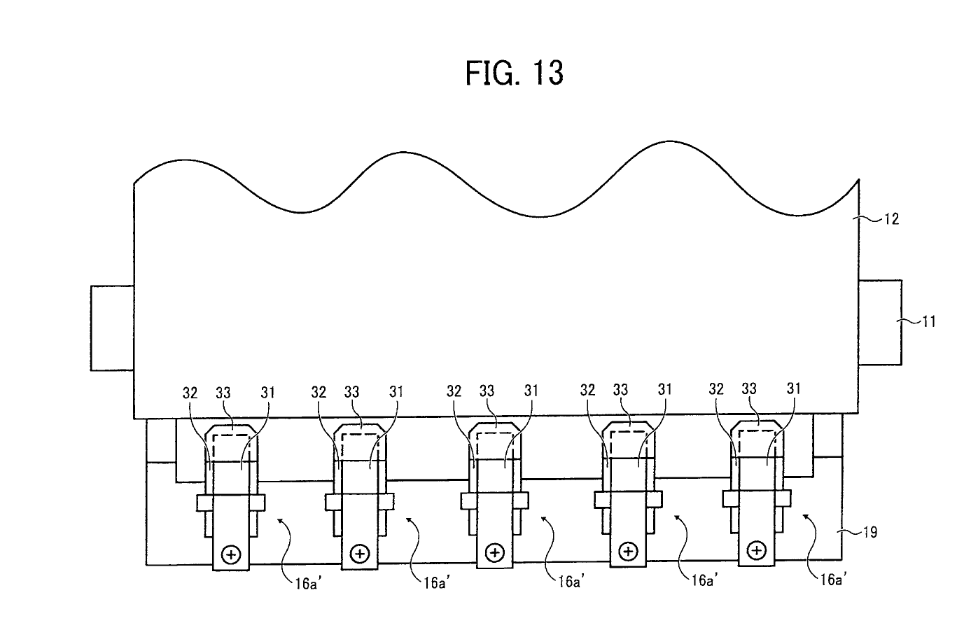

The separation pick is not limited to the above, and a different type can be employed in the fixing device 100 as shown in FIG. 13. As shown, the separation pick 16a′ includes a plate like base 31 made of harder material than fluorocarbon resin, and the fluorocarbon resin serving as an insertion member, while a fluorocarbon resin layer 32 and a leading end section 33 are integrally molded using injection molding. At this moment, the leading end 33 of the separation pick 16a′ only includes the fluorocarbon resin having a constant width along the widthwise direction of the fixing belt 12 and is arranged in the vicinity of the fixing belt 12. The fluorocarbon resin layer 32 faces the sheet ejection path. Plural separation picks 16a′ having the constant width are arranged along the widthwise direction of the fixing belt (or in the direction of a roller shaft when a fixing roller is employed). Further, only one separation pick 16a′ can be used. However, it is more preferable to arrange the plural separation picks 16a′ to adjust gaps between the fixing member (a fixing roller or a fixing belt), because a separation performance can be improved.

Obviously, numerous additional modifications and variations of the present invention are possible in light of the above teachings. It is therefore to be understood that within the scope of the appended claims, the present invention may be practiced otherwise than as specifically described herein.

What is claimed is:

1. An image forming apparatus, comprising:
a fixing device configured to fix a toner image onto a printing medium, said fixing device including;
a heating device configured to generate heat;
a fixing member heated by the heating device;
a pressurizing member freely rotatably pressure contacts the fixing member and configured to create a fixing nip on the surface of the fixing member;
a separation member arranged downstream of the fixing nip and configured to prevent the printing medium from at least winding up the fixing member;
at least three sensors aligned on widthwise center and side ends of a conveyance path conveying the printing medium downstream of the separation member, said at least three sensors being configured to detect passage of the printing medium; and
a fixing jam detection device configured to detect jamming of the printing medium based on outputs of the three sensors.

2. The image forming apparatus as claimed in claim 1, wherein said fixing jam detection device detects the jamming when none of the at least three sensors detect the passage of the printing medium when a prescribed time period T has elapsed after the printing medium passes through a prescribed position on a conveyance path upstream of the fixing device.

3. The image forming apparatus as claimed in claim 2, said prescribed time period T is changed in accordance with one of a type of the printing medium and a number of consecutively fed printing mediums.

4. The image forming apparatus as claimed in claim 1, wherein said fixing jam detection device detects the jamming only with the central sensor when a distance between the two side end sensors is larger than the width of the printing medium, said fixing jam detection device detecting jamming with three sensors when the distance between the two end sensors is less than the width of the printing medium.

5. The image forming apparatus as claimed in claim 1, wherein the fixing jam detection device detects jamming only with the central sensor when the printing medium includes a punch hole at its one end.

6. The image forming apparatus as claimed in claim 1, wherein the fixing jam detection device obtains an output from the central sensor representing passage of the leading end of the printing medium, and outputs from the remaining two sensors representing presence of the printing medium.

7. The image forming apparatus as claimed in claim 1, wherein the fixing jam detection device detects the trailing end of the printing medium passing through the fixing nip based on an output of the central sensor.

8. The image forming apparatus as claimed in claim 1, further comprising a switching gate arranged downstream of the fixing device and configured to switch the conveyance path, wherein a time when the switching gate is operated is determined based on a time when the central sensor detects the printing medium.

9. The image forming apparatus as claimed in claim 1, wherein the fixing jam detection device detects remaining of a jam sheet using the central sensor from when the jamming occurs to when the next fixing process starts.
